(19) United States
(12) Patent Application Publication
(10) Pub. No.: US 2006/0223365 A1
(43) Pub. Date: Oct. 5, 2006

(54) Integral connector module

(76) Inventor: John William Campbell, Monument, CO (US)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 11/096,416

(22) Filed: Mar. 31, 2005

(51) Int. Cl. H01R 13/60

(52) U.S. Cl. 439/540.1

(57) ABSTRACT

A connector module includes a plurality of coaxial connectors, each having an outer portion. The connector module also includes a bulkhead having a board mounting reference surface. The outer portion of each of the coaxial connectors and the bulkhead are integral. An electronic testing device is also described.

### BACKGROUND

Electronic test equipment, such as spectrum analyzers and oscilloscopes, often includes test probes. These probes are used to determine one or more characteristics of an electronic device under test (DUT). The DUT may be an individual electronic device or an electronic circuit. One end of the probe contacts the DUT and another end is connected to the electronic test equipment, which processes data received from the probe for further diagnostic analysis and display.

Commonly, test probes include a connector that is adapted to transmit relatively high frequency signals between the DUT and the electronic test equipment. The connector may be a coaxial connector, such as a bayonet style connector, which is connected to a similar connector by a coaxial transmission line or cable. In addition to the coaxial connector, test probes may include contact pins that make separate electrical connections to the electronic testing device. For example, the contact pins may provide identification information from the probe, or a signal dividing function, or both. Moreover, the electronic test equipment may provide power via the contact pins to operate an active probe.

Regardless of their form or function, the coaxial connector and the contact pins must be properly aligned to respective connectors and contacts on the test equipment in order to make proper electrical connections. For example, if the coaxial connector at the test equipment is rotationally misaligned, the contact pins on the probe may not be aligned to respective contact pads on the testing equipment. Thus, improper electrical connections may occur, resulting in malfunction of the test probe.

Electronic test equipment often includes a plurality of test probe connection sites, each with a coaxial connector and an additional electrical interface. This arrangement requires rather tight tolerances in the center-to-center spacing or pitch of the coaxial connectors in order to maintain the alignment of the additional interface at the test equipment with the respective contacts of the probe connection. Furthermore, the coaxial connectors at the test equipment must be substantially parallel to within certain tolerances in order for the appropriate connections between the probe and the test equipment to occur.

Known techniques to address the alignment requirements include the use of alignment fixtures, which aid in aligning the connectors of the test equipment before the connectors are fastened. Unfortunately, these and other known alignment techniques add to the complexity of assembly by requiring additional hardware; are labor intensive; and often require expensive components. Ultimately, these factors contribute to unacceptable cost of the final assembly.

What is needed, therefore, is a connector module and electronic test device including such connector modules that overcomes at least the shortcomings of the known connector modules described above.

### DEFINED TERMINOLOGY

The following term is defined for the present disclosure:

Integral means comprised of a substantially indivisible part. For example, an integral element may be an indivisible part cast from a mold.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1a is a perspective view of a connector module in accordance with an example embodiment.

FIG. 1b is another perspective view of the connector module in accordance with an example embodiment.

FIG. 1c is a partially exploded view of a connector module and a circuit board in accordance with an example embodiment.

FIG. 1d is a perspective view of the connector module and printed circuit board of FIG. 1c shown in assembled form.

FIG. 2a is a partially exploded view of a connector module, shielding structure(s) and a printed circuit board in accordance with an example embodiment.

FIG. 2b is another partially exploded view of the connector module, shielding structure(s) and printed circuit board of FIG. 2a.

FIG. 3a is a partially exploded view of the connector module and a test probe in accordance with an example embodiment.

FIG. 3b is a front view of two coaxial connectors and two openings in a front circuit board in accordance with an example embodiment.

FIG. 4 is a perspective view of an electronic testing device in accordance with an example embodiment.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

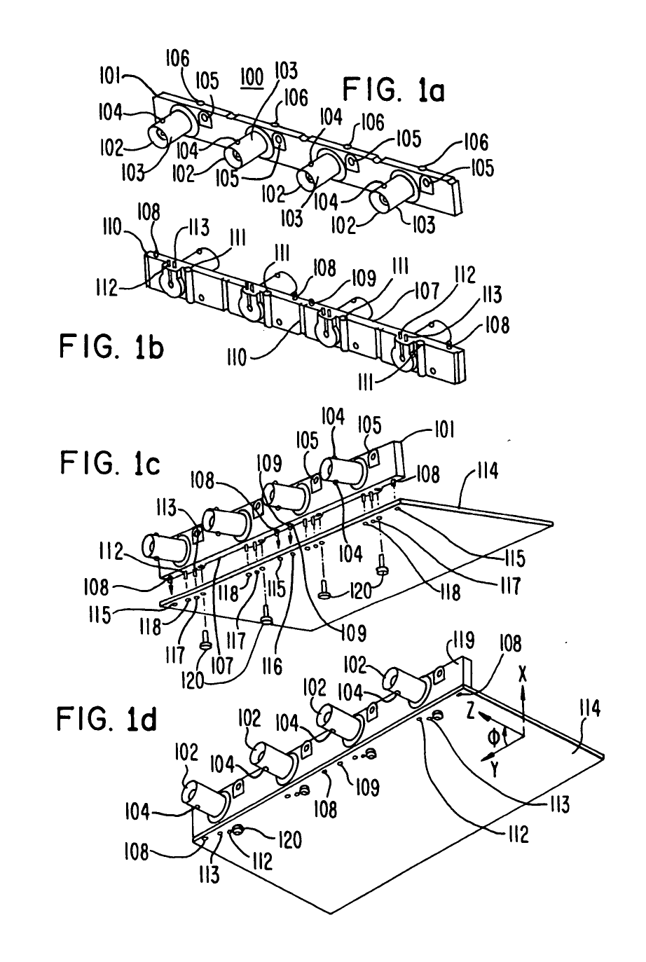

FIG. 1a is a perspective view of a connector module 100 in accordance with an example embodiment. The connector module 100 includes a bulkhead 101 and a plurality of coaxial connectors 102, each having an outer portion 103. The outer portions 103 each include a post 104 or engagement feature on an upper side and a similar post (not shown in FIG. 1a) diametrically oppositely disposed on the lower side. The posts 104 are adapted to engage respective complementary features of a mating coaxial connector (not shown in FIG. 1a). In general, the coaxial connectors 102 are adapted to transmit high frequency signals, such as radio frequency (RF) signals and microwave signals. Illustratively, the coaxial connectors 102 may be bayonet navy connectors (BNCs) or subminiature A (SMA) connectors. While four coaxial connectors 102 are shown in the example embodiment of FIG. 1a, the connector module 100 may include two or more coaxial connectors 102.

The connector module 100 optionally includes a plurality of chassis ground mounting holes 105 and a plurality of shield mounting holes 106. Illustratively, the connector module includes one chassis ground mounting hole 105 and one shield mounting hole 106 for each coaxial connector 102. However, there may be more or fewer than the illustrated number of mounting holes 105, 106 per coaxial connector.

FIG. 1b is another perspective view of the connector module 100 of the example embodiment. FIG. 1b shows the reverse side and lower portion of the connector module 100. The connector module 100 includes a board mounting reference surface 107 having a plurality of alignment pins 108 extending substantially orthogonally thereto. Moreover, the connector module includes a master alignment pin 109, which also extends substantially orthogonally to the board mounting reference surface 107. As shown in FIG. 1b, the alignment pins 108 may be disposed near first and second ends of the board mounting reference surface 107, and the master alignment pin 109 may be disposed near a middle portion of the surface 107. In a specific embodiment, the alignment pins 108 and the master alignment pin 109 are substantially cylindrical. The function and benefits of the alignment pins 108 and master alignment pin 109 are further described herein.

The connector module 100 optionally includes a plurality of shield slots 110, which are adapted to receive electrostatic shields (not shown in FIG. 1b). In addition, the connector module 100 includes a plurality of board mounting holes 111, which are each adapted to receive a fastener (e.g., a screw) so the connector module 100 can be mounted securely to a circuit board (not shown in FIG. 1b). Finally, each coaxial connector 100 includes a center conductor 112 and at least one ground pin 113. These conductors 112 and ground pins 113 are connected to circuit traces on the circuit board, typically by known soldering techniques. Thereby the coaxial connectors 102 are electrically connected to the circuitry on the circuit board.

Notably, the connector module 100 is an integral component. In the disclosed embodiment, at least the bulkhead 101, the board mounting surface 107, the outer portions 103 and posts 104 of the coaxial connectors 102, the alignment pins 108 and the master alignment pin 109 are integral. Moreover, the shield slots 110, the board mounting holes 111, the center pins 112, ground pins 113 and shield mounting holes 106 may be integral with the connector module 100.

In a specific embodiment, the connector module 100 is cast by a known casting technique. The casting provides precise location, dimensions and orientation of the outer portions 103, the posts 104, the alignment pins 108, the master alignment pin 109 and the board mounting reference surface 107. As described further herein, the precision provided by the casting technique to these components fosters the accurate alignment of connectors to the connector module without the need for alignment fixtures during assembly.

In a specific embodiment, the connector module 100 is die cast of an alloy of zinc and aluminum. The alloy of aluminum and zinc provides tolerance control during casting of the connector module 100. In particular, the zinc and aluminum alloy has flow characteristics and shrinkage characteristics during cooling that provide beneficial precision of the components of the connector module. Other manufacturing methods are also suitable for use in the present teachings, the use of a casting of the connector module 100 from a zinc and aluminum alloy material being representative. Other materials and manufacturing techniques within the purview of one of ordinary skill in the art that provide the beneficial precision to the integral connector module 100 are contemplated.

FIG. 1c is a partially exploded view of the connector module 100 and a circuit board 114. The circuit board 114 may be a component of an electronic testing device, such as an oscilloscope or spectrum analyzer. However, the circuit board 114 may be a component of another type of electronic equipment, which includes at least two connections via coaxial connectors.

The connector module 100 is oriented so that the alignment pins 108 pass through respective alignment pin holes 115 on the board, and so that the master alignment pin 109 passes through a master alignment pin hole 116. With the mounting of the alignment pins 108 and the master alignment pin 109 into respective holes on the board 114, the center conductor 112 and the ground pin 113 of each coaxial connector 102 passes through respective center conductor holes 118 and ground pin holes 117. Fasteners 120 (e.g., screws) pass through holes in the circuit board 114 and engage respective board mounting holes 111, which fastens the connector module 100 to the board 114. Soldering of the various conductors 112, 113 may be carried out by known soldering techniques including, but not limited to, hand soldering, wave soldering and fountain soldering.

FIG. 1d shows the connector module 100 mounted to the circuit board 114. The circuit board 114 is located in the y-z plane of the coordinate system shown. The board mounting reference surface 107 is substantially flat, so when mounted to the circuit board 114, the board mounting reference surface 107 is substantially coplanar with the circuit board 114. Among other benefits, the precision in the flatness of the board mounting reference surface 107 aids in orienting the coaxial connectors 102 substantially parallel to the circuit board 114. In a specific embodiment, the surface flatness across its surface the board mounting reference surface 107 is within approximately 0.2 mm. Moreover, the master alignment pin 109 and the alignment pins 108 are disposed at predetermined locations with suitable precision along the board mounting reference surface 107 to engage respective openings in the circuit board 114. The precision of locating the alignment pins 108 and the master alignment pin 109 provides, among other benefits, precision in locating the connector module 100 in the z-direction on the board 114. In a specific embodiment, the alignment pins 108 and master alignment pin 109 are each located on the board mounting reference surface to within approximately ±0.1 mm.

During assembly, the connector module 100 is mounted on the circuit board 114 with the master alignment pin 109 passing through the master alignment pin hole 116 and the alignment pins 108 passing through respective alignment pin holes 115. The master pin 109 sets the lateral (y-position) of the connector module 100 on the board 114. The alignment pins 108 together with the master alignment pin 109 set the position of the connector module 100 on the circuit board 114 in the y-z plane. In addition, the alignment pins 108 aid in resisting rotation of the connector module 100 about its y-axis (i.e., ‘tilt’), and the rotation of the connector module 100 about the x-axis (i.e., ‘twist’). As can be appreciated, rotation of the connector module about either the x or y axes can have a deleterious impact on the alignment of the connector module 100 with other elements described herein.

The master alignment pin hole 116 is substantially round and provides rather tight tolerance for the insertion of the master alignment pin. Thus, the precise location of the master alignment pin 109 on the connector module 100 and the relatively tight tolerance of the master alignment pin hole 116 provides precision in the location of the connector module 100 in the y-z plane. Illustratively, the alignment pin holes 115 have greater tolerance in the z-direction than the master alignment pin hole 116. This increased tolerance normally is provided by forming the alignment pin holes 115 of a substantially elliptical shape, where the cross-section of the alignment pins 108 is substantially circular. For example, the minor diameter of the elliptical opening of the alignment pin holes 115 may be substantially the same as or slightly larger than the diameter of the alignment pins, and the major diameter of the ellipse may be larger than the diameter of the diameter of the alignment pins. By providing this tolerance in the holes 115, tolerance mismatch between the circuit board 114 and the connector module 100 can be compensated.

As can be appreciated from the description above, the connector module 100 is located on the circuit board 114 with suitable precision and in a proper orientation via the mounting surface 107, the alignment pins 108 and the master alignment pin 109. The suitable location and proper orientation of certain features of the connector module 100 results from the integral nature of the connector module 100 and is realized without costly fixturing techniques described previously.

In the example embodiment, the bulkhead 101 is cast so its front face 119 is substantially orthogonal to the board mounting reference surface 107 and the outer portions 103 of the coaxial connectors 102 are cast to be substantially perpendicular to the front face 119 and thus substantially parallel to one another. When the connector module is mounted to the circuit board 114, the coaxial connectors 102 are substantially parallel to one another and oriented in the z-direction.

In addition, and as detailed herein, the connector module 100 is cast so that the center-to-center spacing of the coaxial connectors 102 is suitably precise, and so that the posts 104 are accurately located on the outer portion 103 of the respective coaxial connectors. The posts 104 set the angular orientation of the mating coaxial connectors. Specifically, in the coordinate system shown in FIG. 1d, the posts 104 set the angular position (φ) in the x-y plane of the mating connector relative to the respective coaxial connector 102. Furthermore, the posts 104 are cast in a substantially fixed orientation relative to the board mounting reference surface 107.

As detailed herein, the substantially parallel coaxial connectors 102, the precision in the center-to-center spacing of the coaxial connectors 102 and the precision of the location of the posts 114 provided by the integral connector module 100 aid in the alignment of the coaxial connectors to other connectors and connection interfaces.

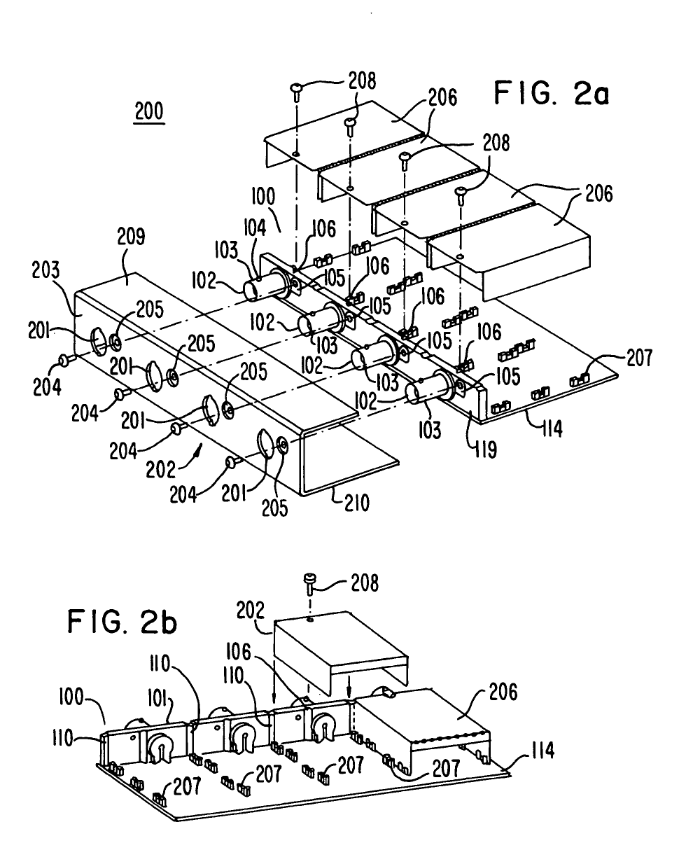

FIG. 2a is a partially exploded view of connection assembly 200 in accordance with an example embodiment. The connection assembly 200 includes features common to the example embodiment described in connection with FIGS. 1a-1d. To the extent practical, the details of these common features will be foregone in order to avoid obscuring the description of the present example embodiment.

In the present example embodiment, the connector module 100 is mounted over the circuit board 114. The outer portions 103 of the coaxial connectors are passed through respective openings 201 in a chassis 202. The coaxial connectors 102 at least partially protrude through a front face 203 of the chassis 202 in order to mate with respective mating connectors (not shown). The chassis 202 is fastened to the front face 119 of the bulkhead 101 via fasteners (e.g. screws) 204 that engage respective chassis ground mounting holes 105 via respective openings 205 in the chassis 202. As can be appreciated, in many high frequency applications, grounding of certain components is beneficial to accurate signal transmission. The fastening of the connector module 100 to the chassis 202 via fasteners 204 fosters the suitable grounding of the connector module 100.

As shown in FIGS. 2a and 2b, the connection assembly 200 includes a plurality of electrostatic shields 206, which are disposed over the circuit board 114. The shields 206 provide protection to the circuits of the circuit board 114 from cross-talk, and extraneous signals and fields. The details of the function and materials of the shields 206 are well known and thus are not provided. The shields 206 are inserted into respective shield slots 110 of the connector module 100 and engage respective clips 207 disposed over the circuit board 114. The clips 207 are metal in a specific embodiment and may provide additional grounding to the shields 206. After being disposed in the shield slots 110 and engaging clips 207, the shields 206 are further fastened to the bulkhead 101 by fasteners 208 (e.g., screws), which engage respective shield mounting holes 106. Notably, the assembly of the shields 206 with the connector module 100 and circuit board 114 is carried out before the connector module 100 is inserted into the chassis 202. Thus, a top surface 209 of the chassis 202 is adapted to fit over the shields 202; and a bottom surface 210 of the chassis 202 is adapted to fit beneath the bottom surface of the circuit board 114.

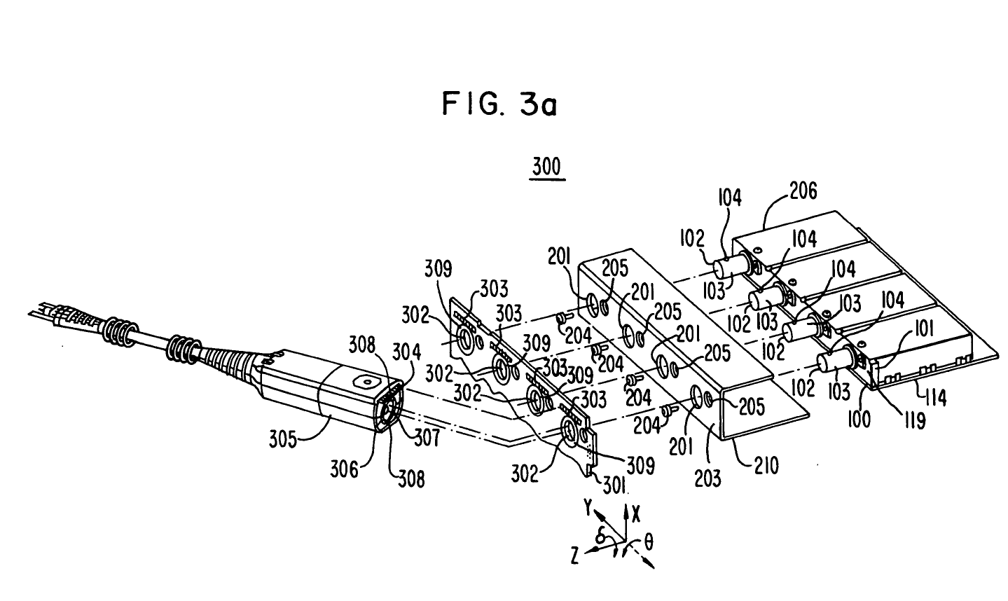

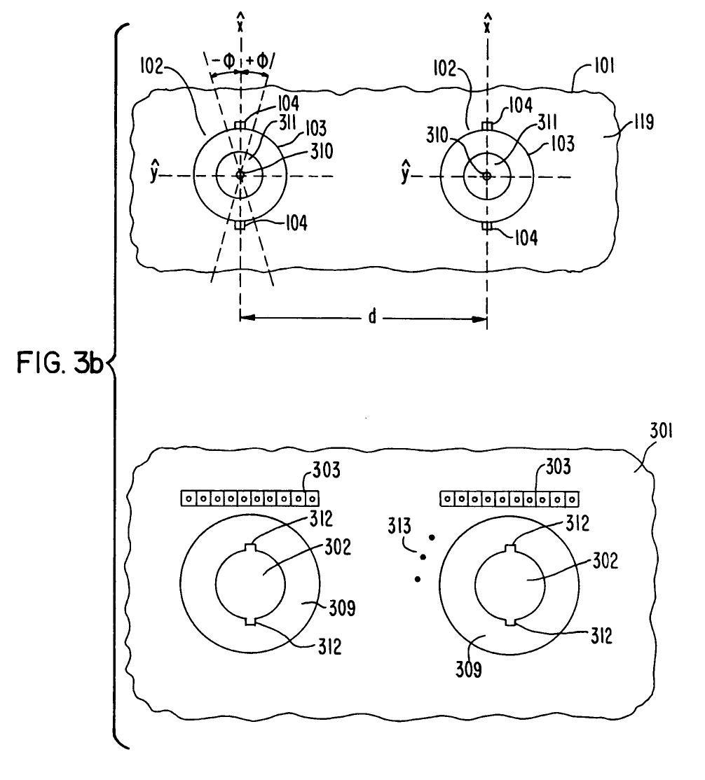

FIG. 3a is a partially exploded view of a connection assembly 300 in accordance with an example embodiment. The connection assembly 300 includes features common to the example embodiment described in connection with FIGS. 1a-2b. To the extent practical, the details of these common features will be foregone in order to avoid obscuring the description of the present example embodiment.

After the connection assembly 200 is assembled, a circuit board 301 is disposed over the front face 203 of the chassis 202, with openings 302 being aligned with openings 201 of the chassis 202. The chassis 202 and the shields 206 are optional. In particular, the front circuit board 301 may be disposed over the front face 119 of the bulkhead 101. Upon assembly, the outer portions 103 and posts 104 of each of the coaxial connectors 102 protrude through the openings 302 in the circuit board 301.

In the present example embodiment, the circuit board 301 includes a plurality of probe contact strips 303 (also referred to as connection interfaces) disposed substantially tangentially to respective openings 302. About each opening 302, the front circuit board 301 optionally includes a tag ring interface 309. The probe contact strips 303 are adapted to engage probe contacts 304 of an electrical connector 305 and the tag ring interface 309 is adapted to engage a probe tag ring (not shown) on the electrical connector 305. While the probe contacts 304 are illustrated as contact pins, other types of contacts may be used. In addition, there may be more or fewer probe contacts 304 than is shown in FIG. 3a.

The electrical connector 305 includes a mating coaxial connector 306, which is adapted to engage the coaxial connector(s) 102. The coaxial connector 306 includes a center contact 307, which is adapted to engage the center contact (not shown in FIG. 3a) of the coaxial connector 102 to which it is mated. The coaxial connector 306 includes diametrically opposed complementary features 308 that engage respective posts 104 of the coaxial connector 102 to which the coaxial connector 306 is mated.

In an example embodiment, the electrical connector 305 is a probe for an electronic testing device. For example, the probe may be of the type described in commonly assigned U.S. Pat. No. 6,095,841 to Felps, the disclosure of which is specifically incorporated herein by reference. As noted previously, the probe contacts 304 and the probe contact strips 303 beneficially provide additional functionality to the probe.

Each of the probe contacts 304 usefully connects a designated contact on the probe contact strip 303 in order to make necessary connection between the probe and the front circuit board 301, and thus the electronic testing device. As such, the contacts 304 must be properly aligned with the probe contact strip 303. In addition, the mating coaxial connector 306 must be suitably aligned to engage its respective coaxial connector 102 of the connection assembly 200.

FIG. 3b is a front view of two coaxial connectors 102 of the connector module 100 and two openings 302 in the front circuit board 301. FIG. 3b is useful in understanding alignment of the coaxial connectors 102 to the front circuit board 301 and thus to the probe 305 via features and tolerances.

The coaxial connectors 102 each include a center contact 310, which is substantially parallel to the z-axis, and a dielectric layer 311. The coaxial connectors 102 of the connector module 100 have a suitably precise center-to-center spacing ‘d’ from the center contact 310 of one coaxial connector 102 to the center contact 310 of any other coaxial connector 102 of the connector module 100. In a specific embodiment, the precision (tolerance) in the center-to-center spacing (d) provided by the integral connector module 100 may be approximately ±0.2 mm; and may be approximately ±0.1 mm. In addition, the coaxial connector(s) 102 of the integral connector module 100 are in rotational alignment with respect to the z-axis. In particular, each coaxial connector 102 includes the diametrically opposed posts 104, as described previously. The posts 104 of the connectors 102 are rotationally aligned (angle of rotation ±φ with respect the x-axis shown in FIG. 3b) with respect to the x-axis passing through the center contact 310 to within approximately ±1.0° or better. Notably, the posts 104 may be rotationally aligned within the range of approximately ±0.50° to approximately ±0.25°. Finally, by virtue of the precision of the board mounting surface 107, the alignment posts 108 and the master alignment post 109 of the integral connector module 100 of the example embodiments, the coaxial connectors 102 are substantially parallel to the circuit board 114.

The coaxial connectors 102 fit through the openings 302, with the posts 104 fitting through respective notches 312. The openings 302 in the front circuit board 301 have a rather precise center-to-center spacing. The precision in the center-to-center spacing of the coaxial connectors 102 of the integral connector module 100 ensures that each connector 102 fits through its respective opening 302 in the front circuit board 301. The precision of the rotational alignments fosters the connection of each of the contact pins 304 with its respective contact of the probe contact strip 303. Notably, the posts 104 provide the rotational alignment in (p of the coaxial connectors 102 with the coaxial connector 306. If the posts 104 were misaligned, the coaxial connector 306 would be rotationally misaligned relative to the z-axis (i.e., rotated out of alignment). Accordingly, the probe contacts 304 would also be misaligned relative to the contacts of the probe contact strip 303. Thus, certain probe contacts 304 may be in contact with the wrong contact on the probe contact strip 303, while others may not be in contact with any contact on the probe contact strip 303.

In addition to, or instead of the probe contact strip 303, which is substantially linear, a connection may be made between radially disposed contacts (not shown) of the probe 305 and the front circuit board 301 via contacts 313, which are substantially radially disposed. In a specific embodiment, the contacts 313 are disposed circumferentially about the tag ring interface 309. Like the probe contact strip 303, the contacts 313 require alignment of respective contacts (not shown) of the probe 305. If there is rotational misalignment of the coaxial connectors 102 as described previously, the alignment of the contacts 313 with respective contacts on the probe 305 may be compromised.

By virtue of the precision of location, dimensions and orientation of the various components of the integral connector module 100, the coaxial connectors 102 have suitable precision in center-to-center spacing; and are rotationally aligned with respect to the z-axis (i.e., within the tolerance in the direction of (P). Moreover, the integral connector module 100 provides parallel coaxial connectors 102. Thereby, the connections of the coaxial connectors 102 with the mating coaxial connector 306, and the connections of the probe contacts 304 with the probe contact strip 303 are provided in a substantially self-aligned manner.

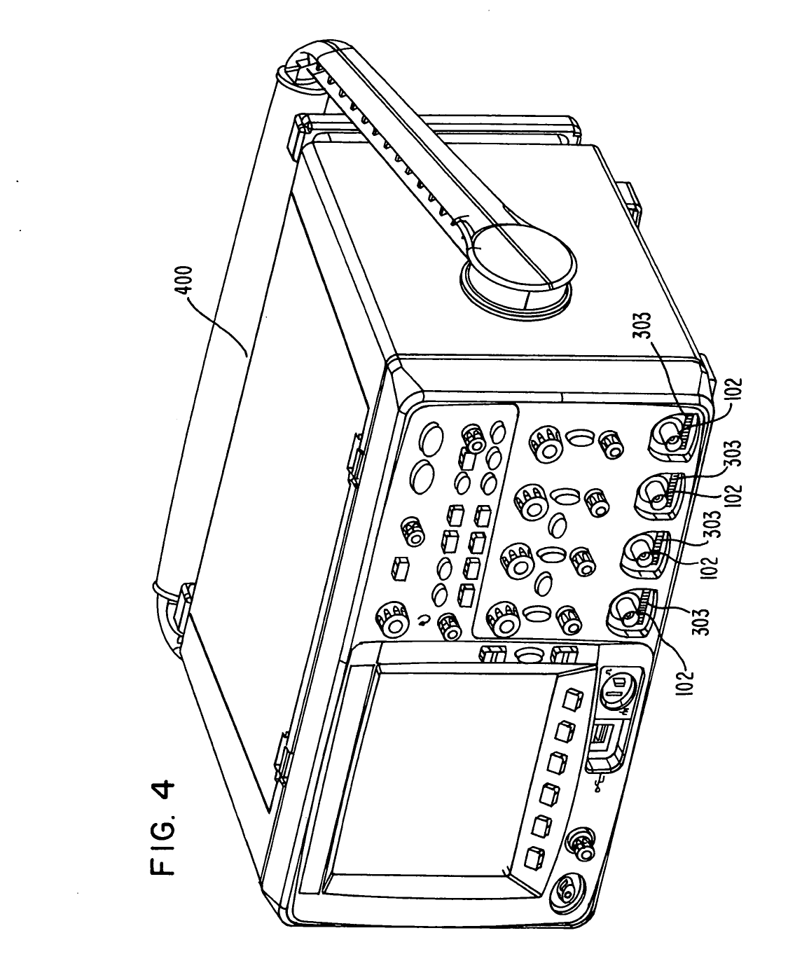

FIG. 4 is a perspective view of an electronic testing device 400 in accordance with an example embodiment. The electronic testing device may be an oscilloscope, a spectrum analyzer or other testing device. As the type of testing device is generally not germane to the example embodiments, specific details are not provided in order to avoid obscuring the description of these embodiments.

The electronic testing device 400 includes the coaxial connectors 102 of the connector module 100 and the probe contact strip 303 of the front circuit board 301, both of which are enclosed within the device housing and thus not visible in FIG. 4. During operation, a probe such as probe 305 is connected to one or more of the coaxial connectors 102 and probe contact strips 303. The device 400 processes signals acquired from the probe 305.

In accordance with illustrative embodiments described, a connector module and an electronic testing device are adapted to connect with a coaxial connector and a connection interface in an aligned manner. One of ordinary skill in the art appreciates that many variations that are in accordance with the present teachings are possible and remain within the scope of the appended claims. For example, other types of connectors and interfaces may be used. These and other variations would become clear to one of ordinary skill in the art after inspection of the specification, drawings and claims herein. The invention therefore is not to be restricted except within the spirit and scope of the appended claims.

1. A connector module, comprising:
a plurality of coaxial connectors each having an outer portion;
a bulkhead having a board mounting reference surface; and
at least two alignment pins, which are substantially orthogonal to the board mounting reference surface, wherein the outer portion of each of the coaxial connectors, the at least two alignment pins and the bulkhead are integral.

2. A connector module as recited in claim 1, wherein each of the plurality of outer portions is substantially cylindrical and includes at least one engagement feature that is adapted to engage a complementary feature of a mating connector.

3. A connector module as recited in claim 2, wherein the at least one engagement feature of each of the plurality of coaxial connectors is aligned in a substantially fixed orientation relative to the board mounting reference surface.

4. A connector module as recited in claim 1, wherein the board mounting reference surface includes a first end, a second end and a middle portion, and the at least two alignment pins further comprise:
a first alignment pin near the first end; a second alignment pin near the second end; a
middle alignment pin near the middle portion; and a master alignment pin near the middle portion.

5. A connector module as recited in claim 4, wherein the alignment pins are integral with the outer portions and the bulkhead.

6. A connector module as recited in claim 4, wherein the board mounting reference surface is adapted to mount over a circuit board and each of the alignment pins is adapted to engage respective openings in the circuit board.

7. A connector module as recited in claim 1, wherein the bulkhead comprises a front surface substantially orthogonal to the board mounting reference surface and wherein the outer surface of each of the plurality of coaxial connectors protrudes substantially orthogonally from the front surface.

8. A connector module as recited in claim 6, further comprising at least one electrostatic shielding element disposed over the circuit board.

9. A connector module as recited in claim 1, further comprising a chassis having a plurality of openings adapted to receive the plurality of coaxial connectors therethrough.

10. A connector module as recited in claim 1, further comprising a front circuit board disposed over a front face of the bulkhead, wherein the front circuit board includes a plurality of holes adapted to receive the plurality of coaxial connectors therethrough.

11. A connector module as recited in claim 10, further comprising a plurality of probe contact strips disposed over the front circuit board, wherein one of the plurality of probe contact strips is oriented substantially tangentially to each of the plurality of holes.

12. A connector module as recited in claim 10, further comprising a plurality of contacts disposed over the front circuit board, wherein at least two of the plurality of contacts are disposed in a substantially radial pattern to at least one of the plurality of holes.

13. An electronic testing device, comprising:
a plurality of coaxial connectors each having an outer portion;
a bulkhead having a board mounting reference surface; and
at least two alignment pins, which are substantially orthogonal to the board mounting reference surface, wherein the outer portion of each of the coaxial connectors, the at least two alignment pins and the bulkhead are integral.

14. An electronic testing device as recited in claim 13, wherein each of the plurality of outer portions is substantially cylindrical and includes at least one engagement feature that is adapted to engage a complementary feature of a mating connector.

15. An electronic testing device as recited in claim 13, wherein the bulkhead comprises a front surface substantially orthogonal to the board mounting reference surface and wherein the outer surface of each of the plurality of coaxial connectors protrudes substantially orthogonally from the front surface.

16. An electronic testing device as recited in claim 15, further comprising:
a front circuit board disposed over a front face of the bulkhead, wherein the front circuit board includes a plurality of holes adapted to receive the plurality of coaxial connectors therethrough.

17. An electronic testing device as recited in claim 16, further comprising a plurality of probe contact strips disposed over the front circuit board, wherein one of the plurality of probe contact strips is oriented substantially tangentially to each of the plurality of holes.

18. An electronic testing devices as recited in claim 16, further comprising a plurality of contacts disposed over the front circuit board, wherein at least two of the plurality of contacts are disposed in a substantially radial pattern to at least one of the plurality of holes.

19. An electronic testing device as recited in claim 17, further comprising:
a probe, which includes a mating coaxial connector and a probe pin strip, wherein the mating coaxial connector is adapted to engage any of the plurality of coaxial connectors and the probe pin strip is adapted to engage the probe contact strip.

20. An electronic testing device as recited in claim 18, further comprising:
a probe, which includes a mating coaxial connector and a plurality of contacts, wherein the mating coaxial connector is adapted to engage any of the plurality of coaxial connectors and the plurality of contacts is adapted to engage the plurality of contacts disposed over the front circuit board.

21. An electronic testing device as recited in claim 16, further comprising a chassis adapted to receive the plurality of coaxial connectors therethrough, wherein the front circuit board is disposed over the chassis.

22. An electronic testing device as recited in claim 14, wherein the engagement feature of each of the plurality of coaxial connectors is aligned in a substantially fixed orientation relative to the board mounting reference surface.

23. An electronic testing device as recited in claim 13, wherein the board mounting reference surface includes a first end, a second end and a middle portion, and the at least two alignment pins further comprise:
a first alignment pin near the first end; a second pin near the second end; a middle alignment pin near the middle portion; and a master alignment pin near the middle portion, wherein each of the alignment pins protrudes substantially orthogonally from the mounting reference surface.

24. An electronic testing device as recited in claim 23, wherein each of the alignment pins is integral with the outer portions and the board mounting reference surface.

25. An electronic testing device as recited in claim 13, wherein the board mounting reference surface is adapted to mount over a circuit board and the at least two alignment pins are adapted to engage respective openings in the circuit board.
